(19) United States
(12) Patent Application Publication
(10) Pub. No.: US 2010/0215959 A1
(43) Pub. Date: Aug. 26, 2010

(54) SILANES

(76) Inventors: Gerhard Jonschker, Spiesen-Elversberg (DE); Matthias Koch, Wiesbaden (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 11/917,964

(22) PCT Filed: Oct. 26, 2006
(86) PCT No.: PCT/EP06/10329

§ 371 Date: Dec. 18, 2007

(30) Foreign Application Priority Data
Nov. 25, 2005 (DE) 10 2005 056 620.0

(51) Int. Cl. B32B 1/00; C07F 7/10

(52) U.S. Cl. 428/403; 556/419; 556/420; 556/423; 977/773

(57) ABSTRACT

The present invention relates to silanes, in particular amphiphilic silanes, to processes for the preparation of the silanes, to the use thereof for the surface modification of particles, and to particles whose surface has been modified by means of the silanes.

The present invention relates to silanes, in particular amphiphilic silanes, to processes for the preparation of the silanes, to the use thereof for the surface modification of particles, and to particles whose surface has been modified by means of the silanes.

Silanes are increasing in importance in many areas of industry, in particular in the modification of surfaces. This relates both to macroscopic surfaces, for example of buildings, monuments, etc., but in addition also increasingly to the surface of particles of microscopic size, for example in the nanometre or micron region.

In the commonest applications, the silanes have the job of modifying the surface properties of the articles coated therewith. In the simplest case, application of a hydrophobic silane hydrophobicises the surface as a whole and thus makes it, for example, less sensitive to moisture or dirt. In addition, hydrophobic silanes are also suitable for, for example, modifying the alignment properties of pearlescent pigments in corresponding coatings, as described, for example, in EP 0 634 459.

Other examples relate to the use of silanes containing reactive groups which are able to form covalent bonds, for example by reaction with an ambient medium. Examples thereof are given in WO 98/13426, which discloses silane-modified pearlescent pigments for water-borne coating systems in which the reactive group is able to form bonds to the polymer of the water-borne coating.

The silanes mentioned all have the disadvantage that they are in each case only able to achieve one functional property, either hydrophobicisation of the particles coated therewith or the provision of an additional reactive group on the surface of the particles. However, it is often desired, and virtually essential, in particular, in the area of nanotechnology, that a plurality of properties can be combined with one another in order to be able to provide multifunctional particles. There is therefore a demand for novel multifunctional silanes which combine a plurality of different properties with one another in order to be able to provide, for example, particles with multifunctional properties in the course of surface modification.

The object of the present invention is accordingly to provide novel silanes which satisfy the above-mentioned complex requirement profile.

Surprisingly, it has been found that the silanes according to the invention meet these requirements. Accordingly, the present invention relates to silanes, in particular amphiphilic silanes, of the general formula (I)

(R)₃Si—Sₚ-Aₕₚ-B_{hb} (I)

where the radicals R may be identical or different and represent radicals which can be cleaved off hydrolytically,
Sₚ denotes either —O— or straight-chain or branched alkyl having 1-18 C atoms, straight-chain or branched alkenyl having 2-18 C atoms and one or more double bonds, straight-chain or branched alkynyl having 2-18 C atoms and one or more triple bonds, saturated, partially or fully unsaturated cycloalkyl having 3-7 C atoms, which may be substituted by alkyl groups having 1-6 C atoms,
Aₕₚ denotes a hydrophilic block,
B_{hb} denotes a hydrophobic block, and
where at least one reactive functional group is bonded to Aₕₚ and/or B_{hb}.

The silanes according to the invention have the advantage that they combine a plurality of properties in themselves. They can provide, for example, particles with a surface having hydrophilic properties via the hydrophilic block and at the same time with a surface having hydrophobic properties via the hydrophobic block. This gives rise to self-organised switchability of the hydrophilicity/hydrophobicity, depending on the environment of the particle surface. In addition, the additional reactive functional groups are able to form further bonds, for example to an ambient medium. The surface of the particles is thus adapted to a very wide variety of applications by a single modification and thus becomes compatible for all applications. In addition, the amphiphilic silanes in accordance with the present invention have, owing to the relatively long chain length, increased mobility with respect to the alignment and orientation of the silanes, for example on a surface. This supports improved alignment of the respective areas of the amphiphilic silane which interact with the ambient medium and thus likewise improves the compatibility of the particles coated therewith a very wide variety of media.

Essential for the silanes according to the invention is the structure of the individual sub-units, as depicted in formula (I).

The silanes contain a head group (R)₃Si, where the radicals R may be identical or different and represent radicals which can be cleaved off hydrolytically. The radicals R are preferably identical.

Suitable radicals which can be cleaved off hydrolytically are, for example, alkoxy groups having 1 to 10 C atoms, preferably having 1 to 6 C atoms, halogens, hydrogen, acyloxy groups having 2 to 10 C atoms and in particular having 2 to 6 C atoms or NR′₂ groups, where the radicals R′ may be identical or different and are selected from hydrogen or alkyl having 1 to 10 C atoms, in particular having 1 to 6 C atoms. Suitable alkoxy groups are, for example, methoxy, ethoxy, propoxy or butoxy groups. Suitable halogens are, in particular, Br and Cl. Examples of acyloxy groups are acetoxy or propoxy groups. Oximes are furthermore also suitable as radicals which can be cleaved off hydrolytically. The oximes here may be substituted by hydrogen or any desired organic radicals. The radicals R are preferably alkoxy groups and in particular methoxy or ethoxy groups.

A spacer Sₚ, which functions as bonding element between the Si head group and the hydrophilic block Aₕₚ and takes on a bridging function for the purposes of the present invention, is covalently bonded to the above-mentioned head group. The group Sₚ is either —O— or straight-chain or branched alkyl having 1-18 C atoms, straight-chain or branched alkenyl having 2-18 C atoms and one or more double bonds, straight-chain or branched alkynyl having 2-18 C atoms and one or more triple bonds, saturated, partially or fully unsaturated cycloalkyl having 3-7 C atoms, which may be substituted by alkyl groups having 1-6 C atoms.

The C₁-C₁₈-alkyl group of Sₚ is, for example, a methyl, ethyl, isopropyl, propyl, butyl, sec-butyl or tert-butyl group, furthermore also a pentyl, 1-, 2- or 3-methylbutyl, 1,1-, 1,2- or 2,2-dimethylpropyl, 1-ethylpropyl, hexyl, heptyl, octyl, nonyl, decyl, undecyl, dodecyl, tridecyl or tetradecyl group. It may optionally be perfluorinated, for example as difluoromethyl, tetrafluoroethyl, hexafluoropropyl or octafluorobutyl group.

A straight-chain or branched alkenyl having 2 to 18 C atoms, where a plurality of double bonds may also be present, is, for example, vinyl, allyl, 2- or 3-butenyl, isobutenyl, sec-butenyl, furthermore 4-pentenyl, isopentenyl, hexenyl, heptenyl, octenyl, —C₉H₁₆, —C₁₀H₁₈ to —C₁₈H₃₄, preferably allyl, 2- or 3-butenyl, isobutenyl, sec-butenyl, furthermore preferably 4-pentenyl, isopentenyl or hexenyl.

A straight-chain or branched alkynyl having 2 to 18 C atoms, where a plurality of triple bonds may also be present, is, for example, ethynyl, 1- or 2-propynyl, 2- or 3-butynyl, furthermore 4-pentynyl, 3-pentynyl, hexynyl, heptynyl, octynyl, —C₉H₁₄, —C₁₀H₁₆ to —C₁₈H₃₂, preferably ethynyl, 1- or 2-propynyl, 2- or 3-butynyl, 4-pentynyl, 3-pentynyl or hexynyl.

Unsubstituted saturated or partially or fully unsaturated cycloalkyl groups having 3-7 C atoms can be cyclopropyl, cyclobutyl, cyclopentyl, cyclohexyl, cycloheptyl, cyclopentenyl, cyclopenta-1,3-dienyl, cyclohexenyl, cyclohexa-1,3-dienyl, cyclohexa-1,4-dienyl, phenyl, cycloheptenyl, cyclohepta-1,3-dienyl, cyclohepta-1,4-dienyl or cyclohepta-1,5-dienyl groups which are substituted by C₁- to C₆-alkyl groups.

The spacer group Sₚ is followed by the hydrophilic block Aₕₚ. This can be selected from nonionic, cationic, anionic or zwitterionic hydrophilic polymers, oligomers or groups. In the simplest embodiment, the hydrophilic block is an ammonium, sulfonium or phosphonium group, an alkyl chain containing carboxyl, sulfate and phosphate side groups, where the latter may also be in the form of a corresponding salt, a partially esterified anhydride containing a free acid or salt group, an OH-substituted alkyl or cycloalkyl chain (for example sugars) containing at least one OH group, an NH— and SH-substituted alkyl or cycloalkyl chain or a mono-, di-, tri- or oligoethylene glycol group. The length of the corresponding alkyl chain can be 1 to 20 C atoms, preferably 1 to 6 C atoms.

The nonionic, cationic, anionic or zwitterionic hydrophilic polymers, oligomers or groups here can be prepared from corresponding monomers by polymerisation by methods known in general terms to the person skilled in the art. Suitable hydrophilic monomers here contain at least one dispersing functional group which is selected from the group consisting of
(i) functional groups which can be converted into anions by means of neutralisers, and anionic groups, and/or
(ii) functional groups which can be converted into cations by means of neutralisers and/or quaternising agents, and cationic groups, and/or
(iii) nonionic hydrophilic groups.

The functional groups (i) are preferably selected from the group consisting of carboxyl, sulfonyl and phosphonyl groups, acidic sulfuric acid and phosphoric acid ester groups and carboxylate, sulfonate, phosphonate, sulfate ester and phosphate ester groups, the functional groups (ii) are preferably selected from the group consisting of primary, secondary and tertiary amino groups, primary, secondary, tertiary and quaternary ammonium groups, quaternary phosphonium groups and tertiary sulfonium groups, and the functional groups (iii) are preferably selected from the group consisting of omega-hydroxy- and omega-alkoxypoly(alkylene oxide)-1-yl groups.

If unneutralised, the primary and secondary amino groups can also serve as isocyanate-reactive functional groups.

Examples of highly suitable hydrophilic monomers containing functional groups (i) are acrylic acid, methacrylic acid, beta-carboxyethyl acrylate, ethacrylic acid, crotonic acid, maleic acid, fumaric acid or itaconic acid; olefinically unsaturated sulfonic or phosphonic acids or partial esters thereof; or mono(meth)acryloyloxyethyl maleate, mono(meth)acryloyloxy-ethyl succinate or mono(meth)acryloyloxyethyl phthalate, in particular acrylic acid and methacrylic acid.

Examples of highly suitable hydrophilic monomers containing functional groups (ii) are 2-aminoethyl acrylate and methacrylate or allylamine.

Examples of highly suitable hydrophilic monomers containing functional groups (iii) are omega-hydroxy- or omega-methoxypolyethylene oxid-1-yl, omega-methoxypolypropylene oxid-1-yl or omega-methoxypoly(ethylene oxide-co-polypropylene oxide)-1-yl acrylate or methacrylate, and hydroxyl-substituted ethylenes, acrylates or methacrylates, such as, for example, hydroxyethyl methacrylate.

Examples of suitable monomers for the formation of zwitterionic hydrophilic polymers are those in which a betaine structure occurs in the side chain. The side group is preferably selected from —(CH₂)ₘ—(N⁺(CH₃)₂)—(CH₂)ₙ—SO₃—, —(CH₂)ₘ—(N⁺(CH₃)₂)—(CH₂)ₙ—PO₃²⁻, —(CH₂)ₘ—(N⁺(CH₃)₂)—(CH₂)ₙ—O—PO₃²⁻ or —(CH₂)ₘ—(P⁺(CH₃)₂)—(CH₂)ₙ—SO₃⁻, where m stands for an integer from the range 1 to 30, preferably from the range 1 to 6, particularly preferably 2, and n stands for an integer from the range 1 to 30, preferably from the range 1 to 8, particularly preferably 3.

It may be particularly preferred here if at least one structural unit of the hydrophilic block has a phosphonium or sulfonium radical.

In general, corresponding structures can be prepared in accordance with the following scheme:

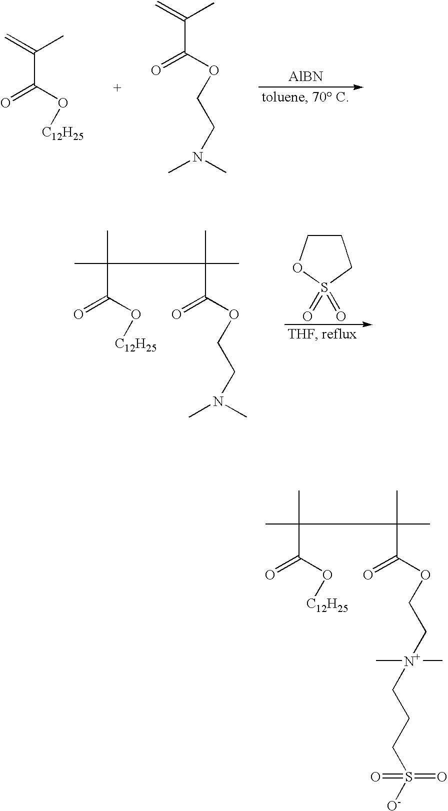

The desired amounts of lauryl methacrylate (LMA) and dimethylaminoethyl methacrylate (DMAEMA) are copolymerised here by known processes, for example by means of free radicals in toluene by addition of AIBN. A betaine structure is subsequently obtained by reaction of the amine with 1,3-propane sultone by known methods.

In another variant of the invention, it is preferred to employ a copolymer essentially consisting of lauryl methacrylate (LMA) and hydroxyethyl methacrylate (HEMA), which can be prepared in a known manner by free-radical polymerisation with AIBN in toluene.

When selecting the hydrophilic monomers, it should be ensured that the hydrophilic monomers containing functional groups (i) and the hydrophilic monomers containing functional groups (ii) are preferably combined with one another in such a way that insoluble salts or complexes are not formed. By contrast, the hydrophilic monomers containing functional groups (i) or containing functional groups (ii) can be combined as desired with the hydrophilic monomers containing functional groups (iii).

Of the hydrophilic monomers described above, the monomers containing functional groups (i) are particularly preferably used.

The neutralisers for the functional groups (i) which can be converted into anions are preferably selected here from the group consisting of ammonia, trimethylamine, triethylamine, tributylamine, dimethylaniline, diethylaniline, triphenylamine, dimethylethanolamine, diethylethanolamine, methyl-diethanolamine, 2-aminomethylpropanol, dimethylisopropylamine, di-methylisopropanolamine, triethanolamine, diethylenetriamine and triethylenetetramine, and the neutralisers for the functional groups (ii) which can be converted into cations are preferably selected from the group consisting of sulfuric acid, hydrochloric acid, phosphoric acid, formic acid, acetic acid, lactic acid, dimethylolpropionic acid and citric acid.

The hydrophilic block is very particularly preferably selected from mono-, di- and triethylene glycol structural units.

The hydrophobic block B_{hb} follows bonded to the hydrophilic block Aₕₚ. The block B_{hb} is based on hydrophobic groups or, like the hydrophilic block, on hydrophobic monomers which are suitable for polymerisation.

Examples of suitable hydrophobic groups are straight-chain or branched alkyl having 1-18 C atoms, straight-chain or branched alkenyl having 2-18 C atoms and one or more double bonds, straight-chain or branched alkynyl having 2-18 C atoms and one or more triple bonds, saturated, partially or fully unsaturated cycloalkyl having 3-7 C atoms, which may be substituted by alkyl groups having 1-6 C atoms. Examples of such groups have already been mentioned above. In addition, aryl, polyaryl, aryl-C₁-C₆-alkyl or esters having more than 2 C atoms are suitable. The said groups may in addition also be substituted, in particular by halogens, where perfluorinated groups are particularly suitable.

Aryl-C₁-C₆-alkyl denotes, for example, benzyl, phenylethyl, phenylpropyl, phenylbutyl, phenylpentyl or phenylhexyl, where both the phenyl ring and also the alkylene chain may be partially or fully substituted by F as described above, particularly preferably benzyl or phenylpropyl.

Examples of suitable hydrophobic olefinically unsaturated monomers for the hydrophobic block Bₕₚ are

(1) essentially acid group-free esters of olefinically unsaturated acids, such as (meth)acrylic acid, crotonic acid, ethacrylic acid, vinylphosphonic acid or vinylsulfonic acid alkyl or cycloalkyl esters having up to 20 carbon atoms in the alkyl radical, in particular methyl, ethyl, propyl, n-butyl, sec-butyl, tert-butyl, hexyl, ethylhexyl, stearyl and lauryl acrylate, methacrylate, crotonate, ethacrylate or vinyl phosphonate or vinyl sulfonate; cycloaliphatic (meth)-acrylic acid, crotonic acid, ethacrylic acid, vinylphosphonic acid or vinyl-sulfonic acid esters, in particular cyclohexyl, isobornyl, dicyclopentadienyl, octahydro-4,7-methano-1H-indenemethanol or tert-butylcyclohexyl (meth)-acrylate, crotonate, ethacrylate, vinylphosphonate or vinylsulfonate. These may contain secondary amounts of higher-functional (meth)acrylic acid, crotonic acid or ethacrylic acid alkyl or cycloalkyl esters, such as ethylene glycol, propylene glycol, diethylene glycol, dipropylene glycol, butylene glycol, pentane-1,5-diol, hexane-1,6-diol, octahydro-4,7-methano-1H-indenedimethanol or cyclohexane-1,2-, -1,3- or -1,4-diol di(meth)acrylate, trimethylolpropane tri(meth)acrylate or pentaerythritol tetra(meth)acrylate, and the analogous ethacrylates or crotonates. For the purposes of the present invention, secondary amounts of higher-functional monomers (1) is taken to mean amounts which do not result in crosslinking or gelling of the polymers;
(2) monomers which carry at least one hydroxyl group or hydroxymethyl-amino group per molecule and are essentially free from acid groups, such as
hydroxyalkyl esters of alpha,beta-olefinically unsaturated carboxylic acids, such as hydroxyalkyl esters of acrylic acid, methacrylic acid and ethacrylic acid, in which the hydroxyalkyl group contains up to 20 carbon atoms, such as 2-hydroxyethyl, 2-hydroxypropyl, 3-hydroxypropyl, 3-hydroxybutyl, 4-hydroxybutyl acrylate, methacrylate or ethacrylate; 1,4-bis(hydroxymethyl)cyclohexane, octahydro-4,7-methano-1H-indene-dimethanol or methylpropanediol monoacrylate, monomethacrylate, mono-ethacrylate or monocrotonate; or products of the reaction of cyclic esters, such as, for example, epsilon-caprolactone, and hydroxyalkyl esters thereof;
olefinically unsaturated alcohols, such as ally alcohol;
allyl ethers of polyols, such as trimethylolpropane monoallyl ether or pentaerythritol mono-, di- or triallyl ether. The higher-functional monomers are generally only used in secondary amounts. For the purposes of the present invention, secondary amounts of higher-functional monomers is taken to mean amounts which do not result in crosslinking or gelling of the polymers;
products of the reaction of alpha,beta-olefinically unsaturated carboxylic acids with glycidyl esters of an alpha-branched monocarboxylic acid having 5 to 18 carbon atoms in the molecule. The reaction of the acrylic or methacrylic acid with the glycidyl ester of a carboxylic acid having a tertiary alpha-carbon atom can take place before, during or after the polymerisation reaction. The monomer (2) employed is preferably the product of the reaction of acrylic and/or methacrylic acid with the glycidyl ester of Versatic® acid. This glycidyl ester is commercially available under the name Cardura® E10. For more information, reference is made to Römpp Lexikon Lacke and Druckfarben [Römpp's Lexicon of Surface Coatings and Printing Inks], Georg Thieme Verlag, Stuttgart, New York, 1998, pages 605 and 606;
formaldehyde adducts of aminoalkyl esters of alpha,beta-olefinically unsaturated carboxylic acids and of alpha,beta-olefinically unsaturated carboxamides, such as N-methylol and N,N-dimethylolaminoethyl acrylate, -aminoethyl methacrylate, -acrylamide and -methacrylamide; and
acryloxysilane groups and hydroxyl groups containing olefinically unsaturated monomers, which can be prepared by reaction of hydroxyl-functional silanes with epichlorohydrin 30 and subsequent reaction of the intermediate with an alpha,beta-olefinically unsaturated carboxylic acid, in particular acrylic acid and methacrylic acid, or hydroxyalkyl esters thereof;
   (3) vinyl esters of alpha-branched monocarboxylic acids having 5 to 18 carbon atoms in the molecule, such as the vinyl esters of Versatic® acid, which are marketed under the brand VeoVa®;
   (4) cyclic and/or acyclic olefins, such as ethylene, propylene, but-1-ene, pent-1-ene, hex-1-ene, cyclohexene, cyclopentene, norbornene, butadiene, isoprene, cyclopentadiene and/or dicyclopentadiene;
   (5) amides of alpha,beta-olefinically unsaturated carboxylic acids, such as (meth)acrylamide, N-methyl-, N,N-dimethyl-, N-ethyl-, N,N-diethyl-, N-propyl-, N,N-dipropyl-, N-butyl-, N,N-dibutyl- and/or N,N-cyclohexylmethyl-(meth)acrylamide;
   (6) monomers containing epoxide groups, such as the glycidyl ester of acrylic acid, methacrylic acid, ethacrylic acid, crotonic acid, maleic acid, fumaric acid and/or itaconic acid;
   (7) vinylaromatic hydrocarbons, such as styrene, vinyltoluene or alpha-alkylstyrenes, in particular alpha-methylstyrene;
   (8) nitriles, such as acrylonitrile or methacrylonitrile;
   (9) vinyl compounds selected from the group consisting of vinyl halides, such as vinyl chloride, vinyl fluoride, vinylidene dichloride, vinylidene di-fluoride; vinylamides, such as N-vinylpyrrolidone; vinyl ethers, such as ethyl vinyl ether, n-propyl vinyl ether, isopropyl vinyl ether, n-butyl vinyl ether, isobutyl vinyl ether and vinyl cyclohexyl ether; and vinyl esters, such as vinyl acetate, vinyl propionate and vinyl butyrate;
   (10) allyl compounds selected from the group consisting of ally ethers and esters, such as propyl allyl ether, butyl allyl ether, ethylene glycol diallyl ether, trimethylolpropane triallyl ether or allyl acetate or allyl propionate; the above-said applies correspondingly to the higher-functional monomers;
   (11) siloxane or polysiloxane monomers, which may be substituted by saturated, unsaturated, straight-chain or branched alkyl groups or other hydrophobic groups already mentioned above. Also suitable are polysiloxane macromonomers which have a number average molecular weight Mn of 1000 to 40,000 and on average 0.5 to 2.5 ethylenically unsaturated double bonds per molecule, such as polysiloxane macromonomers which have a number average molecular weight Mn of 1000 to 40,000 and on average 0.5 to 2.5 ethylenically unsaturated double bonds per molecule; in particular polysiloxane macromonomers which have a number average molecular weight Mn of 2000 to 20,000, particularly preferably 2500 to 10,000 and in particular 3000 to 7000, and on average 0.5 to 2.5, preferably 0.5 to 1.5, ethylenically unsaturated double bonds per molecule, as described in DE 38 07 571 A1 on pages 5 to 7, DE 37 06 095 A1 in columns 3 to 7, EP 0 358 153 B1 on pages 3 to 6, in U.S. Pat. No. 4,754,014 A1 in columns 5 to 9, in DE 44 21 823 A1 or in international patent application WO 92/22615 on page 12, line 18, to page 18, line 10; and
   (12) monomers containing carbamate or allophanate groups, such as acryl-oyloxy- or methacryloyloxyethyl, -propyl or -butyl carbamate or allophanate; further examples of suitable monomers which contain carbamate groups are described in the patent specifications U.S. Pat. No. 3,479,328 A1, U.S. Pat. No. 3,674,838 A1, U.S. Pat. No. 4,126,747 A1, U.S. Pat. No. 4,279,833 A1 or U.S. Pat. No. 4,340,497 A1.

The polymerisation of the above-mentioned monomers can be carried out in any manner known to the person skilled in the art, for example by poly-additions or cationic, anionic or free-radical polymerisations. Polyadditions are preferred in this connection since different monomer types can thus be combined with one another in a simple manner, such as, for example, epoxides with dicarboxylic acids or isocyanates with diols.

The respective hydrophilic and hydrophobic blocks can in principle be combined with one another in any desired manner. The amphiphilic silanes in accordance with the present invention preferably have an HLB value in the range 2-19, preferably in the range 4-15. The HLB value here is defined as

$$H L B = \frac{mass of polar fractions}{molar mass} \cdot 20$$

and indicates whether the silane behaves more hydrophilic or hydrophobic, i.e. which of the two blocks Aₕₚ and B_{hb} dominates the properties of the silane according to the invention. The HLB value is calculated theoretically and arises from the proportions by weight of hydrophilic and hydrophobic groups. An HLB value of 0 indicates a lipophilic compound; a chemical compound having an HLB value of 20 has only hydrophilic components.

The silanes of the present invention are furthermore distinguished by the fact that at least one reactive functional group is bonded to Aₕₚ and/or B_{hb}. The reactive functional group is preferably bonded to the hydrophobic block B_{hb}, particularly preferably to the end of the hydrophobic block. In the preferred embodiment, the head group (R)₃Si and the reactive functional group have the greatest possible separation. This facilitates particularly flexible design of the chain lengths of the blocks Aₕₚ and B_{hb} without significantly restricting the potential reactivity of the reactive groups, for example with the ambient medium.

The reactive functional group can be selected from silyl groups containing radicals which can be cleaved off hydrolytically, OH, carboxyl, NH or SH groups, halogens or reactive groups containing double bonds, such as, for example, acrylate or vinyl groups. Suitable silyl groups containing radicals which can be cleaved off hydrolytically have already been described above in the description of the head group (R)₃Si. The reactive group is preferably an OH group.

The present invention likewise relates to processes for the preparation of the silanes according to the invention, in particular the amphiphilic silanes, where suitable precursors are converted in a chemical reaction into silanes of the formula (I). In principle, there are no restrictions regarding the way in which the reaction is carried out. In the simplest case, an amphiphilic silane can be obtained in one step by the reaction of suitable starting compounds. For example, an amphiphilic silane in accordance with the present invention can be prepared in accordance with the following scheme:

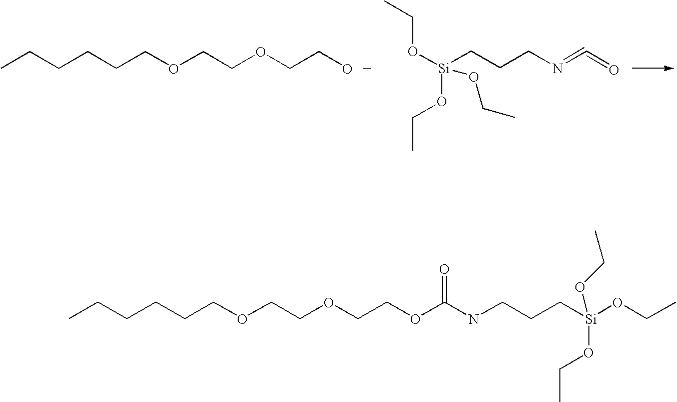

The two starting substances here are, for example, combined under protective gas in toluene and reacted with one another overnight at 90° C. The silane can subsequently be isolated and purified by any method known to the person skilled in the art.

In the case of the polymerisation of suitable monomers, the hydrophilic or hydrophobic block can be polymerised first in a first step. In a subsequent second step, the respective other block is then polymerised onto the first block obtained in the first step.

Preferred amphiphilic silanes have a head group (R)₃Si, where the radicals R denote methoxy or ethoxy, a spacer Sₚ containing straight-chain alkyl having 1-18 C atoms, a hydrophilic block selected from mono-, di- and triethylene glycol structural units, and a hydrophobic block consisting of straight-chain alkyl having 1-18 C atoms. The reactive functional group bonded to the hydrophilic or hydrophobic block is preferably selected from OH, carboxyl, NH, SH, acrylate or vinyl groups.

The silanes according to the invention, in particular the amphiphilic silanes, are particularly suitable for the modification of particle surfaces. Accordingly, the present invention likewise relates to the use of silanes, alone or in combination with other surface modifiers, for the surface modification of particles. In principle, there are no restrictions here for the particles which can be employed. The particles can accordingly be particles of any shape and size, for example spherical or platelet-shaped particles. Examples of corresponding platelet-shaped particles are, for example, pigments from the group of the effect pigments, as described, for example, in Research Disclosures RD 471001 and RD 472005.

The particles are preferably nanoparticles. Nanoparticles are usually prepared in aqueous dispersion and have to be transferred into organic media. If, for example, the hydrophilic nanoparticles are brought into a nonpolar environment too quickly here, agglomeration of the particles occurs. For this reason, the standard processes are usually based on very slow solvent exchange, frequently via promoting solvents in large amount. These multi-step processes are slow and complex. In particular in the case of nano-particles, the use of the silanes according to the invention is therefore particularly advantageous since it enables surface modification which facilitates effective stabilisation of the particles both in a hydrophilic, but also in a hydrophobic environment. The phase transfer is thus simplified by the use of the silanes according to the invention. It is assumed here that this stabilisation could be attributable to the mobility of the chain of the amphiphilic silane. Depending on the environment, the hydrophilic or hydrophobic block faces the ambient medium.

Suitable nanoparticles are selected from the group consisting of hydrophilic and hydrophobic, in particular hydrophilic, nanoparticles based on oxides or hydroxides of silicon, titanium, zinc, aluminium, cerium, cobalt, chromium, nickel, iron, yttrium and/or zirconium, which may optionally be coated with oxides or hydroxides of silicon, or based on metals coated with oxides or hydroxides of silicon, such as, for example, Ag, Cu, Fe, Au, Pd, Pt or alloys. The individual oxides may also be in the form of mixtures. The particles preferably have an average particle size, determined by means of a Malvern ZETASIZER (dynamic light scattering) or transmission electron microscope, of 3 to 200 nm, in particular of 20 to 80 nm and very particularly preferably of 30 to 50 nm. In specific, likewise preferred embodiments of the present invention, the distribution of the particle sizes is narrow, i.e. the variation latitude is less than 100% of the average, particularly preferably a maximum of 50% of the average.

Particular preference is given to the use of nanoparticles based on silicon dioxide.

Very particular preference is also given to the use of nanohectorites, which are marketed, for example, by Südchemie under the brand Optigel® or by Laporte under the brand Laponite®. Silica sols (SiO₂ in water), prepared from ion-exchanged water-glass, are furthermore also particularly preferred.

The present invention likewise relates to particles whose surface has been modified by means of one or more silanes according to the invention, alone or in combination with other surface modifiers.

Suitable further surface modifiers for combination with the silanes according to the invention are, for example, organofunctional silanes, quaternary ammonium compounds, phosphonates, phosphonium and sulfonium compounds or mixtures thereof. The additional surface modifiers are preferably selected from the group of the organofunctional silanes.

The requirements of a surface modifier that are described are met, in particular, in accordance with the invention by an adhesion promoter which carries two or more functional groups. One group of the adhesion promoter reacts chemically with the oxide surface of the nanoparticle. Alkoxysilyl groups (for example methoxy- or ethoxysilanes), halosilanes (for example chlorosilanes) or acidic groups of phosphoric acid esters or phosphonic acids and phosphonic acid esters are suitable here. The groups described are linked to a second functional group via a spacer of varying length. This spacer is an unreactive alkyl chain, siloxane, polyether, thioether or urethane or a combination of these groups of the general formula (C,Si)ₙHₘ(N,O,S)ₓ where n=1-50, m=2-100 and x=0-50. The functional group is preferably an acrylate, methacrylate, vinyl, amino, cyano, isocyanate, epoxide, carboxyl or hydroxyl group.

Silane-based surface modifiers are described, for example, in DE 40 11 044 C2. Surface modifiers based on phosphoric acid are obtainable, inter alia, as Lubrizol® 2061 and 2063 from LUBRIZOL (Langer & Co.). Suitable silanes are, for example, vinyltrimethoxysilane, aminopropyl-triethoxysilane, N-ethylamino-N-propyldimethoxysilane, isocyanatopropyl-triethoxysilane, mercaptopropyltrimethoxysilane, vinyltriethoxysilane, vinyl-ethyldichlorosilane, vinylmethyldiacetoxysilane, vinylmethyldichlorosilane, vinylmethyldiethoxysilane, vinyltriacetoxysilane, vinyltrichlorosilane, phenyl-vinyldiethoxysilane, phenylallyldichlorosilane, 3-isocyanatopropoxytri-ethoxysilane, methacryloxypropenyltrimethoxysilane, 3-methacryloxypropyl-trimethoxysilane, 3-glycidyloxypropyltrimethoxysilane, 1,2-epoxy-4-(ethyl-triethoxysilyl)cyclohexane, 3-acryloxypropyltrimethoxysilane, 2-methacryl-oxyethyltrimethoxysilane, 2-acryloxyethyltrimethoxysilane, 3-methacryloxy-propyltriethoxysilane, 3-acryloxypropyltrimethoxysilane, 2-methacryloxy-ethyltriethoxysilane, 2-acryloxyethyltriethoxysilane, 3-methacryloxypropyl-tris(methoxyethoxy)silane, 3-methacryloxypropyltris(butoxyethoxy)silane, 3-methacryloxypropyltris(propoxy)silane, 3-methacryloxypropyltris(butoxy)-silane, 3-acryloxypropyltris(methoxyethoxy)silane, 3-acryloxypropyltris-(butoxyethoxy)silane, 3-acryloxypropyltris(propoxy)silane and 3-acryloxy-propyltris(butoxy)si lane. 3-Methacryloxypropyltrimethoxysilane is particularly preferred. These and further silanes are commercially available, for example, from ABCR GmbH & Co., Karlsruhe, or Sivento Chemie GmbH, Düsseldorf.

Vinylphosphonic acid and diethyl vinylphosphonate may also be mentioned here as adhesion promoters (manufacturer: Hoechst A G, Frankfurt am Main).

The present invention likewise furthermore relates to processes for the preparation of the particles according to the invention. The processes according to the invention comprise the reaction of one or more of the silanes according to the invention with the particles to be modified, preferably in a solvent or solvent mixture. Processes of this type are known to the person skilled in the art and can be adapted to the respective requirements. The solvent or solvent mixture can comprise, for example, water, alcohols, ethers and ketones.

The following examples merely illustrate the invention without restricting the scope of protection. In particular, the features, properties and advantages described therein of the defined compound(s) on which the example in question is based can also be applied to other substances and compounds which are not mentioned in detail, but fall under the scope of protection of the claims, unless stated to the contrary elsewhere.

### EXAMPLES

### Example 1

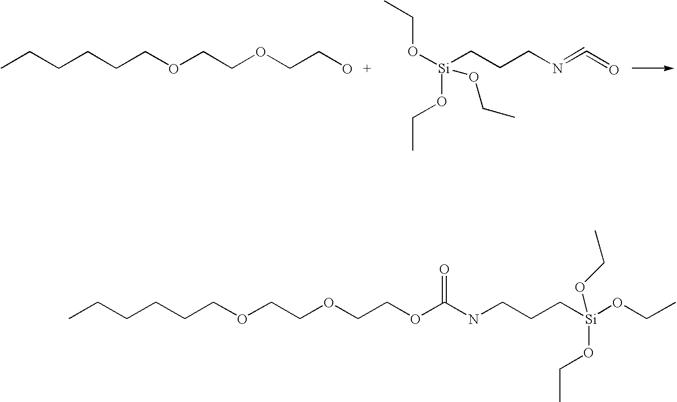

a)

Equimolar amounts of isocyanatopropyltriethoxysilane and diethylene glycol monohexyl ether are combined in a nitrogen round-bottomed flask in toluene under protective gas and stirred overnight at 90° C. on a reflux condenser. Reaction monitoring by means of thin-layer chromatography (toluene: ethyl acetate 1:1) shows virtually complete reaction. All volatile constituents are removed in a rotary evaporator.

b)

0.208 g of each of the silane from Example a) and methacryloxypropyl-trimethoxysilane (ratio 1:1) are added to 55.50 g of ion-exchanged silica sol Levasil 300/30 (SiO₂ particles, diameter 10 nm, from H. C. Starck, Germany). In total, 10% of silane, based on the proportion of SiO₂ particles, are added.

The mixture is stirred for 48 hours, giving a one-phase reaction batch which exhibits slight turbidity.

c)

100 ml of isopropanol and 100 ml of 1-butanol are added to 25.64 g of the mixture from Example b). Removal of water and isopropanol by distillation gives a clear solution. 4.48 g of Laromer LR 8987 (UV-curable acrylic resin from BASF, Germany) are subsequently added, and the butanol is removed by distillation. The amount of Laromer corresponds to an SiO₂: Laromer ratio of 30%: 70%. The coating material obtained is clear, yellowish and liquid.

d)

100 ml of isopropanol and 100 ml of 1-butanol are added to 30.16 g of the mixture from Example b). Removal of water and isopropanol by distillation gives a clear solution. 2.26 g of Laromer LR 8987 (UV-curable acrylic resin from BASF, Germany) are subsequently added, and the butanol is removed by distillation. The amount of Laromer corresponds to an SiO₂: Laromer ratio of 50%: 50%. The coating material obtained is clear, yellowish and liquid.

### Example 2

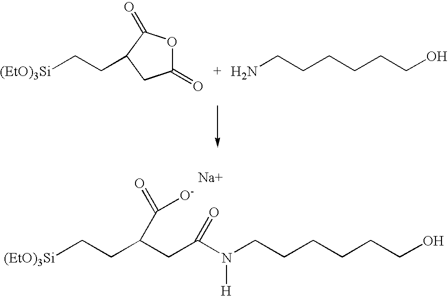

a)

50 g of THF, 30.4 g of Geniosil GF 20 (triethoxysilylpropylsuccinic anhydride, Wacker, Germany) and 11.7 g of 1-aminohexanol are mixed and refluxed for one hour with stirring. The tetrahydrofuran is subsequently removed by distillation.

b)

2 g of the reaction product from step a) are added to 100 g of anionically stabilised silica sol (Levasil 200/30, H. C. Starck, Germany), and the mixture is stirred at room temperature for 24 hours. 800 g of isopropanol are subsequently added, and the solvent is removed by distillation until a solids content of 30% by weight is achieved. A translucent, stable dispersion of SiO₂ in isopropanol results.

### Example 3

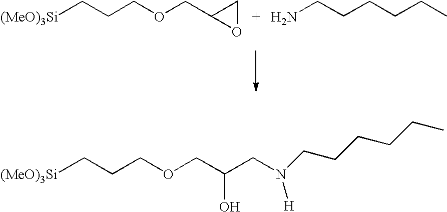

a)

23.6 g of glycidoxypropyltrimethoxysilane are added dropwise with stirring to a solution of 10.1 g of 1-aminohexane in 50 g of tetrahydrofuran, and the mixture is subsequently refluxed for one hour. The tetrahydrofuran is subsequently removed by distillation.

b)

2 g of the reaction product from step a) are added to 100 g of anionically stabilised silica sol (Levasil 200/30, H. C. Starck, Germany), and the mixture is stirred at room temperature for 24 h. 800 g of isopropanol are subsequently added, and the solvent is removed by distillation until a solids content of 30% by weight is achieved. A translucent, stable dispersion of SiO₂ in isopropanol results.

Examples 1 to 3 show that the particles coated with amphiphilic silanes can be incorporated into various media.

1. Silanes of the general formula (I)
(R)₃Si—Sₚ-Aₕₚ-B_{hb} (I)
where the radicals R may be identical or different and represent radicals which can be cleaved off hydrolytically,
Sₚ denotes either —O— or straight-chain or branched alkyl having 1-18 C atoms, straight-chain or branched alkenyl having 2-18 C atoms and one or more double bonds, straight-chain or branched alkynyl having 2-18 C atoms and one or more triple bonds, saturated, partially or fully unsaturated cycloalkyl having 3-7 C atoms, which may be substituted by alkyl groups having 1-6 C atoms,
Aₕₚ denotes a hydrophilic block,
B_{hb} denotes a hydrophobic block, and
where at least one reactive functional group is bonded to Aₕₚ and/or B_{hb}.

2. Silanes according to claim 1, characterised in that the radicals R are alkoxy groups having 1 to 10 C atoms, halogens, hydrogen, acyloxy groups having 2 to 10 C atoms or NR′₂ groups, where the radicals R may be identical or different and are selected from hydrogen and alkyl having 1 to 10 C atoms.

3. Silanes according to claim 1, characterised in that the hydrophilic block Aₕₚ is selected from nonionic, cationic, anionic or zwitterionic hydrophilic polymers, oligomers or groups.

4. Silanes according to claim 1, characterised in that the hydrophobic block B_{hb} is based on hydrophobic groups or on the polymerisation of hydrophobic monomers.

5. Silanes according to claim 1, characterised in that the reactive functional group is selected from OH, carboxyl, NH or SH groups, halogens or reactive groups containing double bonds.

6. Silanes according to claim 1, characterised in that the silanes are amphiphilic.

7. Process for the preparation of silanes according to claim 1, characterised in that suitable precursors are converted in a chemical reaction into silanes of the formula (I).

8. Method of silanes according to claim 1, alone or in combination with other surface modifiers, for the surface modification of particles.

9. A method according to claim 8, characterised in that the particles are nanoparticles.

10. A method according to claim 9, characterised in that the nanoparticles are based on oxides or hydroxides of silicon, titanium, zinc, aluminium, cerium, cobalt, chromium, nickel, iron, yttrium and/or zirconium or mixtures thereof, which may optionally be coated with oxides or hydroxides of silicon, or are based on metals coated with oxides or hydroxides of silicon, such as, for example, Ag, Cu, Fe, Au, Pd, Pt or alloys.

11. Particles whose surface has been modified by means of one or more silanes according to claim 1, alone or in combination with other surface modifiers.

12. Particles according to claim 11, characterised in that the particles are nanoparticles based on oxides or hydroxides of silicon, titanium, zinc, aluminium, cerium, cobalt, chromium, nickel, iron, yttrium and/or zirconium or mixtures thereof, which may optionally be coated with oxides or hydroxides of silicon, or based on metals coated with oxides or hydroxides of silicon, such as, for example, Ag, Cu, Fe, Au, Pd, Pt or alloys.

13. Particles according to claim 11, characterised in that the surface modifier is selected from the group consisting of organofunctional silanes, quaternary ammonium compounds, phosphonates, phosphonium and sulfonium compounds or mixtures thereof.

14. Process for the preparation of particles according to claim 11, comprising the reaction of silanes of formula (I) with the particles to be modified, preferably in a solvent or solvent mixture.
